(19) United States
(12) Patent Application Publication
(10) Pub. No.: US 2005/0262541 A1
(43) Pub. Date: Nov. 24, 2005

(54) Reception device, station selection method, and stream distribution system

(75) Inventor: Hiroshi Oota, TOKYO (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, TOKYO (JP)

(21) Appl. No.: 10/522,922

(22) PCT Filed: May 21, 2004
(86) PCT No.: PCT/JP04/07334

§ 371 Date: Jan. 31, 2005

(51) Int. Cl. H04N 7/173

(52) U.S. Cl. 725/100; 725/87

(57) ABSTRACT

When an input is switched to another input during monitoring of stream data and the input is returned to the stream data again, the stream data can be easily reproduced from a position just before it is switched to another input. When the input is switched to a DTV broadcast received by an antenna 2 during the reproduction of a video stream transmitted from a video server 10, a receiver 1 requests the video server 10 to stop the reproduction of the video stream and stores information of a position where the reproduction of the video stream is stopped. In the receiver 1, when the input is switched to the video stream side again, the receiver 1 requests the video server 10 to restart the reproduction of the video stream which had been reproduced just before the input has been switched at the previous time. At this time, the position information stored upon transmission of the reproduction stop request is transmitted to the video server 10 and the reproduction of the video stream is started from the position where the input has been switched at the previous time.

### TECHNICAL FIELD

The invention relates to a receiving apparatus, a station selecting method, and a stream distribution system which are suitable when they are used in the case of switching a television broadcast and stream data and receiving the switched one.

### BACKGROUND ART

In recent years, in association with the start of a digital television (hereinafter, abbreviated to DTV) broadcast using a satellite and the progress of preparation for a terrestrial digital television broadcast, a DTV receiver for displaying the television broadcast received as a digital signal has been widespread. In the DTV receiver, generally, the conventional terrestrial analog television broadcast can be also received.

In association with development of a network environment in which high-speed communication can be made in the Internet, a service in which stream data of a video image or the like for such streaming that data is reproduced while it is being received is distributed through the network has been proposed. The stream data is stored into, for example, a contents server on the network. The DTV receiver and the contents server are bidirectionally connected through the network. When the DTV receiver side requests the contents server to distribute a desired video image, the contents server selects the stream data of the requested video image from the stored stream data, reproduces it, and transmits it through the network to the DTV receiver which made the request, thereby distributing the stream data. The transmitted stream data is received and displayed by the DTV receiver.

In the recent television receivers, in many cases, the receiver has a plurality of inputs and can input further another signal of a VTR (Video Tape Recorder) or the like. The user can switch the digital or analog television broadcast, the stream-distributed video image, a video signal outputted from the VTR, and the like in a single DTV receiver and enjoy monitoring them.

In JP-A-2000-253367, a technique in which digital contents or a digital television broadcast program on the Internet can be searched for by using EPG (Electric Program Guide) data and those contents can be switched and monitored on the basis of a search result has been disclosed.

In a television receiver having both of the function of receiving the television broadcast and the function of receiving the stream data which is transmitted through the network, the input can be switched to another input such as a television broadcast or the like even during the reception of the stream data. However, in the case where the input is switched to another input such as a television broadcast or the like while the stream data is received and being displayed, if the stream data is held to be reproduced in the contents server, the reproduction of the stream data proceeds even while the contents by another input is being monitored. Therefore, in the case where the user again switches from another input to the input of the stream data and intends to monitor the sequel of the stream data from the data just before the switching to another input, it is necessary to return a reproducing position of the stream data.

As mentioned above, in the television receiver having both of the function of receiving the television broadcast and the function of receiving the stream data which is transmitted through the network, a function for automatically restarting the reproduction of the stream data from the position returned to the previous reproducing position is demanded.

On the other hand, as shown in an example in FIG. 1, there has been proposed a DTV receiving system in which digital video data by the DTV broadcast which was broadcasted through a satellite 110 and received by an antenna 102 is temporarily stored in a hard disk drive (HDD) 101 built in a receiver 100 which can receive the DTV. The digital video data stored in the HDD 101 is subjected to predetermined signal processes by a signal processing unit 103, converted into a signal which can be displayed by a monitor receiver 120, and supplied to the monitor receiver 120. According to such a construction, the digital video data received in a certain channel by the antenna 102 is continuously stored in the HDD 101.

In such a system, for example, a display is temporarily set into a pause mode to see in detail information of a commercial or the like inserted in a program which has been broadcasted in a certain channel and information by a data broadcast which is superimposed into the video data and broadcasted in the DTV broadcast, and the video data by the received television broadcast is stored into the HDD 101. After that, by continuously executing the storage of the video data into the HDD 101, when the pause mode of the display is cancelled, if the data from a point of time of the setting of the pause mode is sequentially read out from the HDD 101, the continuity of video images which are reproduced before and after the pause mode can be held.

There is considered a method whereby a construction which enables the stream data that is transmitted through the network to be received is added to the above construction. The received stream data is continuously stored into the HDD 101 from the point of time of the switching to another input during the reception of the stream data. When the input is returned from another input to the stream data, by sequentially reading out the stream data stored in the HDD 101 from the data at the point of time of the switching of the input, the reproduction of the stream data from the a switching position of the input can be restarted.

According to the construction of FIG. 1, however, since the HDD 101 is built in the television receiver, there is such a problem that the costs increase due to it. There is also such a problem that since the video data is reproduced while being stored into the HDD 101, a burden on an apparatus is heavy. Further, there is also a possibility that all of the received stream data cannot be stored because of a limited storage capacity of the HDD 101. In this case, there is a problem of a risk that the reproduction is finished on the way.

### DISCLOSURE OF INVENTION

It is, therefore, an object of the invention to provide a receiving apparatus, a station selecting method, and a stream distribution system in which in the case where an input is switched to another input during the monitoring of stream data and the input is again returned to the stream data, reproduction of the stream data from a position just before the switching to another input is enabled without allowing the reception side to possess storing means.

According to the invention, to solve the above problems, there is provided a receiving apparatus which can switch and receive a television broadcast and stream data, comprising: reproducing means for reproducing the received stream data; switching means for switching an input between an input from the reproducing means and another input; and communicating means for communicating with a transmitting source of the stream data, wherein in the case where the input is switched from the input from the reproducing means to such another input by the switching means during the reproduction of the stream data by the reproducing means, a stop request to stop transmission of the stream data is transmitted to the transmitting source of the stream data by the communicating means, and in the case where the input is switched again from such another input to an output from the reproducing means by the switching means, a start request to start the reproduction of the stream data from a position where the transmission of the stream data has been stopped is transmitted to the transmitting source of the stream data by the communicating means.

According to the invention, there is provided a station selecting method which can switch and receive a television broadcast and stream data, comprising the steps of: reproducing the received stream data; switching an input between an input from the reproducing step and another input; and communicating with a transmitting source of the stream data, wherein in the case where the input is switched from the input from the reproducing step to such another input by the switching step during the reproduction of the stream data by the reproducing step, a stop request to stop transmission of the stream data is transmitted to the transmitting source of the stream data by the communicating step, and in the case where the input is switched again from such another input to an output from the reproducing step by the switching step, a start request to start the reproduction of the stream data from a position where the transmission of the stream data has been stopped is transmitted to the transmitting source of the stream data by the communicating step.

According to the invention, there is provided a stream distribution system for distributing stream data to a receiving apparatus which can switch and receive a television broadcast and the stream data, comprising: a stream data server for reproducing and transmitting the stream data; and the receiving apparatus having reproducing means for receiving the stream data transmitted from the stream data server and reproducing the received stream data, switching means for switching an input between an input from the reproducing means and another input, and communicating means for communicating with the stream data server, wherein in the case where the input is switched from the input from the reproducing means to such another input by the switching means during the reproduction of the stream data by the reproducing means, the receiving apparatus transmits a stop request to stop the transmission of the stream data to the stream data server by the communicating means, the stream data server stops the transmission of the stream data by the stream data server in accordance with the stop request, in the case where the input is switched again from such another input to the input from the reproducing means by the switching means, the receiving apparatus transmits a start request to start the reproduction of the stream data from a position where the transmission of the stream data has been stopped to the stream data server by the communicating means, and the stream data server reproduces the stream data from the position where the transmission of the stream data has been stopped and transmits the stream data to the receiving apparatus in accordance with the start request.

As mentioned above, according to the invention, when the input is switched from the stream data to another input during the reproduction of the received stream data, the stop request to stop the transmission of the stream data is transmitted to the transmitting source of the stream data. In the case where the input is switched again from another input to the stream data, the start request to start the reproduction of the stream data from the position where the transmission of the stream data has been stopped is transmitted to the transmitting source of the stream data. Therefore, even if the reception side of the stream data does not possess the storing means of the stream data, in the case where the input is once switched to another input and, thereafter, returned to the stream data, the stream data can be continuously reproduced from the position where the stream data has been stopped at the previous time.

### BRIEF DESCRIPTION OF DRAWINGS

FIG. 1 is a schematic diagram for explaining a system using a DTV receiver having therein a hard disk drive according to the prior art.

FIG. 2 is a schematic diagram schematically showing a construction of an example of a stream distribution system according to the first embodiment of the invention.

FIG. 3 is a schematic diagram showing a construction of an example of a DTV receiver according to the first embodiment of the invention.

FIG. 4 is a flowchart for explaining the operation of the stream distribution system according to the first embodiment of the invention.

FIG. 5 is a sequence chart schematically showing processes of an example in which the DTV receiver requests a video server to pause the transmission of a stream.

FIG. 6 is a sequence chart schematically showing processes of an example in which the DTV receiver requests the video server to start the stream distribution.

FIG. 7 is a block diagram for explaining the second embodiment of the invention.

FIG. 8 is a schematic diagram showing a construction of an example of a history table.

FIG. 9 is a block diagram for explaining the operation using the history table according to the second embodiment of the invention.

FIG. 10 is a sequence chart schematically showing processes according to the second embodiment of the invention.

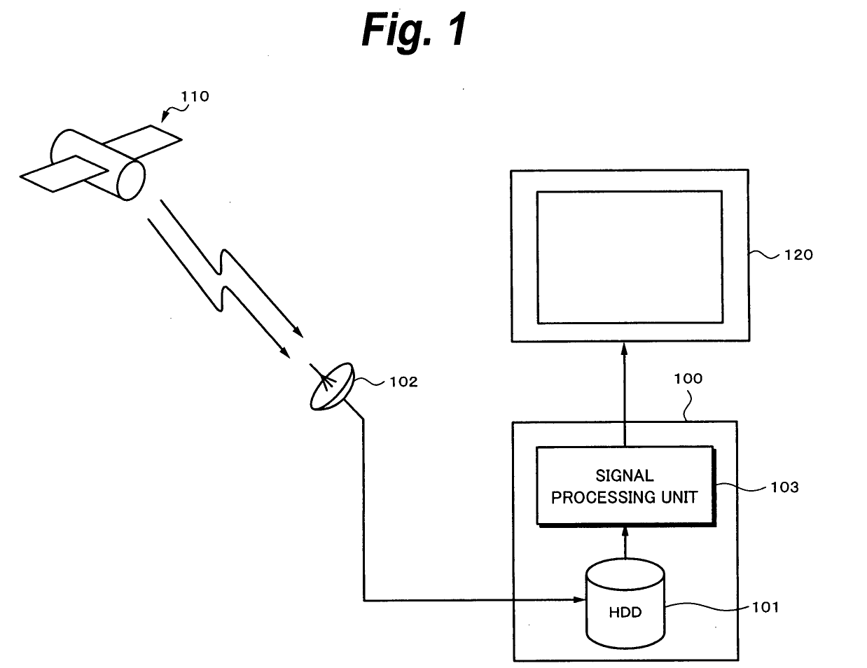

### BEST MODE FOR CARRYING OUT THE INVENTION

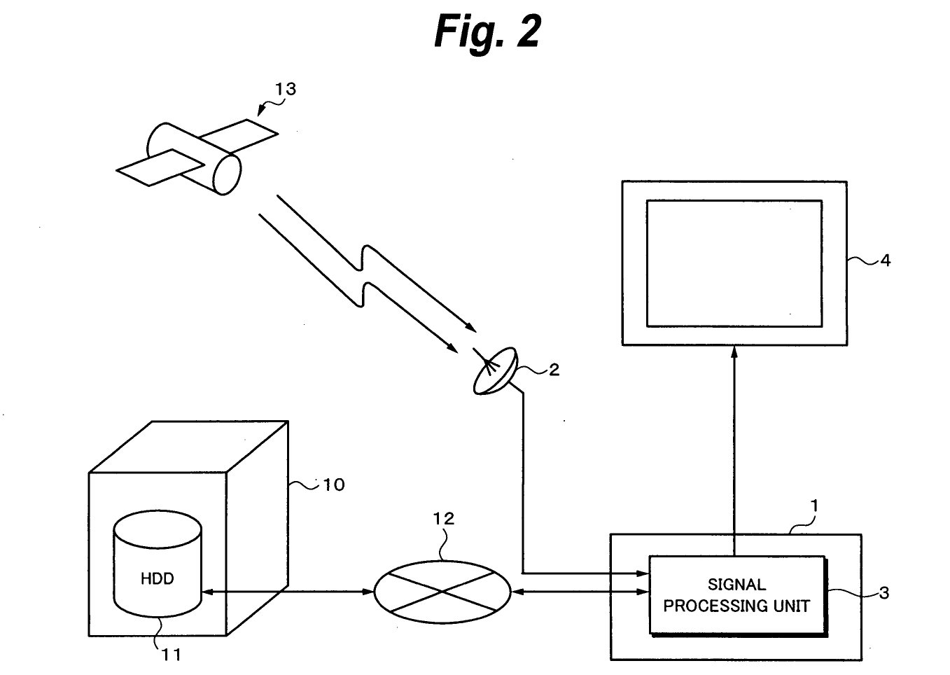

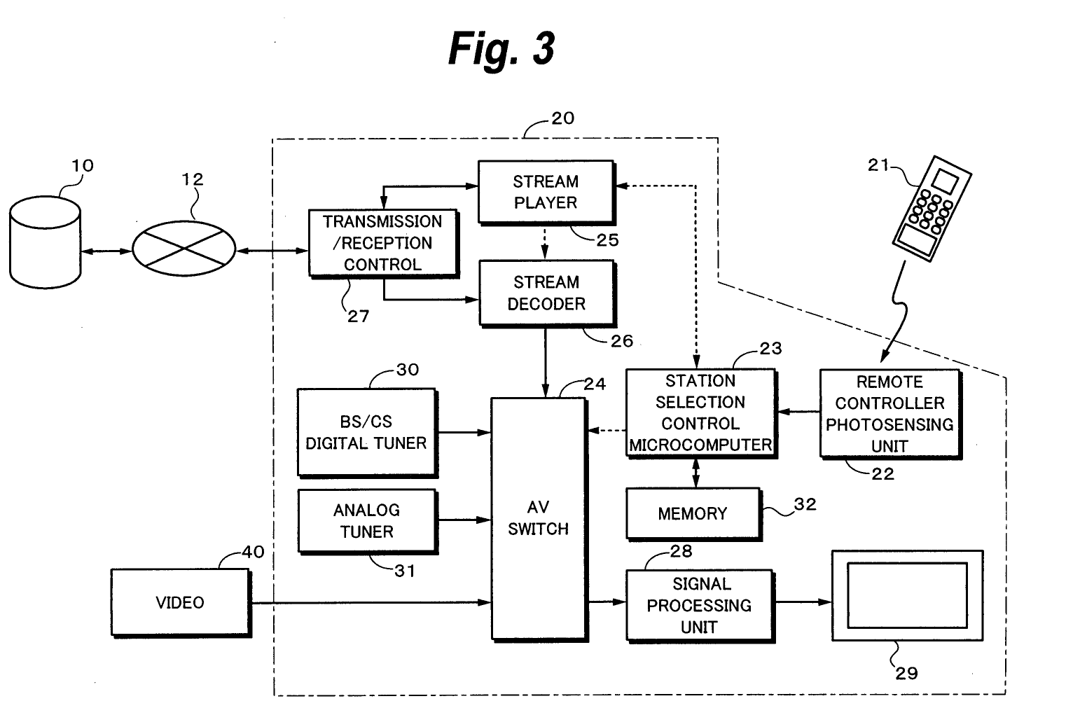

The first embodiment of the invention will be described hereinbelow with reference to the drawings. FIG. 2 schematically shows a construction of an example of a stream distribution system according to the first embodiment of the invention. For example, a digital television (DTV) broadcast radio wave which was broadcasted through a satellite 13 is received by an antenna 2, converted into stream data by a reception processing unit (not shown), and supplied to a signal processing unit 3 of a receiver 1. The signal processing unit 3 executes predetermined processes to the supplied stream data and supplies the processed data to a monitor receiver 4. The monitor receiver 4 displays a video image based on the supplied signal.

A video server 10 is managed by, for example, an Internet video distributing company, reproduces video data stored on a hard disk drive (HDD) 11 as video data storing means, and outputs it as stream data. The outputted stream data is transmitted through an Internet 12 and received by, for example, the receiver 1. In the receiver 1, the received stream data is subjected to the predetermined processes by the signal processing unit 3 and supplied to the monitor receiver 4. The monitor receiver 4 displays a video image based on the supplied signal.

In the following description, the operation to reproduce the stored video data in order to output it as stream data in the video server 10 is properly expressed as “the video stream data is reproduced” or the like.

The receiver 1 can bidirectionally communicate with the video server 10 through the Internet 12. The receiver 1 can switch the stream data based on the signal received by the antenna 2 and the stream data transmitted through the Internet 12 in accordance with the operation to the receiver 1 of the user and input the switched data to the signal processing unit 3.

In the first embodiment of the invention, while the user is monitoring the video image based on the stream data transmitted from the video server 10 by the monitor receiver 4, if the switching of the input to the signal processing unit 3 from the stream data transmitted from the video server 10 to another input is instructed by the operation of the user, a time reproducing position of the stream data at this time is stored. The receiver 1 requests the video server 10 to pause the reproduction of the video stream data. If the input to the signal processing unit 3 is returned from another input to the stream data transmitted from the video server 10, the receiver 1 requests the video server 10 to reproduce the video stream data from the reproducing position (stored in the receiver 1) just before the input to the signal processing unit 3 is switched to another input.

According to the stream distribution system of the first embodiment of the invention constructed as mentioned above, even if the receiver 1 does not have storing means of the stream data such as a hard disk drive or the like, when the user switches the input to the receiver 1 from the stream data transmitted from the video server 10 to another input and returns again from another input to the stream data transmitted from the video server 10, he can monitor the video image based on the stream data transmitted from the video server 10 from a position that is a sequel to the reproducing position just before the input is switched to another input.

FIG. 3 shows a construction of an example of a DTV receiver 20 according to the first embodiment of the invention. The DTV receiver 20 has a structure in which the receiver 1 and the monitor receiver 4 described in FIG. 2 are enclosed in a same casing. The DTV receiver 20 has a BS/CS digital tuner 30 and an analog tuner 31 and can receive a DTV broadcast such as BS (Broadcasting Satellite) broadcast or CS (Communication Satellite) broadcast received by an antenna (not shown), an analog television broadcast using a terrestrial wave, and the like.

On the basis of a station selection instruction signal which is supplied from an AV switch 24, the BS/CS digital tuner 30 receives the broadcast of the channel selected from the BS broadcast and the CS broadcast and outputs a video image and an audio signal based on the received broadcast. The video image and the audio signal outputted from the BS/CS tuner 30 are inputted to the AV (Audio Video) switch 24.

Similarly, on the basis of the station selection instruction signal which is supplied from the AV switch 24, the analog tuner 31 receives the broadcast of the channel selected from the analog television broadcast and outputs a video image and an audio signal based on the received broadcast. The video image and the audio signal outputted from the analog tuner 31 are supplied to the AV switch 24.

The DTV receiver 20 further has external input terminals (not shown) through which an external video image and audio signal can be inputted. A video image and an audio signal outputted from, for example, a VTR (Video Tape Recorder) 40 connected to the external input terminals are inputted to the AV switch 24. Further, a video image and an audio signal which are outputted from a stream decoder 26, which will be explained hereinafter, are supplied to the AV switch 24.

For example, by allowing the AV switch 24 to have an A/D converter therein, the AV switch 24 can cope with the inputs of both of the analog video image and audio signal and the digital video image and audio signal. A larger number of external input terminals can be also provided. With respect to the video image and the audio signal, processes of the video signal will be mainly described hereinbelow and explanation of the audio signal is omitted.

On the basis of the station selection control signal which is supplied from a station selection control microcomputer 23, the AV switch 24 selects the input of one of the BS/CS tuner 30, the analog tuner 31, the external input terminals, and the stream decoder 26. In addition, when the BS/CS tuner 30 or the analog tuner 31 is selected, the AV switch 24 supplies the station selection instruction signal to designate the reception channel to one of the BS/CS tuner 30 and the analog tuner 31 which was selected on the basis of the station selection control signal.

The video signal of one of the BS/CS tuner 30, the analog tuner 31, and the external input terminals which was selected by the AV switch 24 is outputted from the AV switch 24 and supplied to a signal processing unit 28. The video signal subjected to predetermined signal processes by the signal processing unit 28 is supplied to a display unit 29 such as CRT (Cathode Ray Tube), LCD (Liquid Crystal Display), PDP (Plasma Display Panel), or the like. A video image based on the video signal is displayed.

The station selection control microcomputer 23 comprises, for example, a CPU (Central Processing Unit) and has a ROM (Read Only Memory), a RAM (Random Access Memory), and the like. On the basis of programs which have previously been stored in the ROM, the station selection control microcomputer 23 makes the station selection control mentioned above and controls the whole DTV receiver 20. The station selection control microcomputer 23 supplies a control signal to instruct reproduction control of the stream data to a stream player 25, which will be explained hereinafter. The RAM is used as a work memory of the CPU. Further, a memory 32 is connected to the station selection control microcomputer 23.

A remote control commander 21 (hereinafter, abbreviated to a remocon 21) is used to remote-control the DTV receiver 20 by using, for example, an infrared signal. Various operating means necessary for operating the DTV receiver 20 such as channel setting key, input switching key, sound volume setting key, a power ON/OFF key, key (up/down key) to increase/decrease the reception channel one by one, and the like are provided for the remocon 21. When the key is operated by the user, the remocon 21 modulates a control signal according to the operated key into an infrared signal and transmits it.

Although the embodiment has been described here on the assumption that the operating means provided for the remocon 21 are the keys, the invention is not limited to such an example. For example, a cross key which can instruct the upper, lower, right, and left directions, a touch panel whose input is executed by being touched, or the like can be also used as operating means. A dial for setting an input value by being rotated or operating means comprising a combination of the rotating operation and the depressing operation can be also used.

The infrared signal transmitted from the remocon 21 is received by a remote controller photosensing unit 22 of the DTV receiver 20 and the infrared signal is demodulated. The control signal demodulated from the infrared signal is supplied to the station selection control microcomputer 23. On the basis of this control signal, the station selection control microcomputer 23 forms, for example, the foregoing station selection control signal and outputs it to the AV switch 24.

A transmission/reception control unit 27 is connected to the Internet 12 by a communication line whose communicating speed is equal to or higher than, for example, a few Mbps (Mega bits per second) and controls the communication to the Internet 12. An access using a predetermined protocol such as TCP/IP (Transmission Control Protocol/Internet Protocol) is made between the video server 10 and the transmission/reception control unit 27 through the Internet 12, thereby enabling the stream data transmitted from the video server 10 to be received by the DTV receiver 20 and enabling a command and data to be transmitted and received between the DTV receiver 20 and the video server 10.

The video data is stored into a data storing unit (not shown) in the video server 10. The video data is compression encoded by, for example, an MPEG2 (Moving Pictures Experts Group 2) system. In the video server 10, the video data designated by, for example, a title can be read out from the data storing unit, reproduced, and outputted as stream data. The stream data is transmitted onto the Internet 12 on the basis of a stream transmission system specified by, for example, foregoing MPEG2. Naturally, a compression encoding system and a transmission system of the video data are not limited to MPEG2.

The video server 10 makes reproduction control of the video data stored in the data storing unit. For example, reproduction, stop, fast forward reproduction, or rewinding reproduction of the video data (video stream data) is executed on the basis of a request from the outside. The video server 10 can reproduce the video stream data from a start position designated with respect to the time. For example, by giving time information showing the time from the head of the video stream data such as a time code or the like as a start position from the outside, the video stream data can be reproduced from the position corresponding to such time.

A URL (Uniform Resource Locator) showing the location on the Internet 12 has been allocated to the video server 10. By giving the URL through the Internet 12, the video server 10 can be accessed. The invention is not limited to such an example but the URL can be also given to each of the video data stored in the data storing unit of the video server 10. In this case, by designating the URL through the Internet 12, the video stream data to which the URL has been given can be reproduced.

The video stream data which was read out of the data storing unit of the video server 10 and reproduced is transmitted onto the Internet 12. The stream data is received by the transmission/reception control unit 27 and supplied to the stream player 25 and the stream decoder 26.

The stream decoder 26 decodes the supplied stream data and supplies it to the AV switch 24. The stream player 25 controls the reception of the stream data on the basis of the control signal from the station selection control microcomputer 23. For example, in accordance with the control signal from the station selection control microcomputer 23, the stream player 25 transmits a distributing request of the video data to the video server 10 through the transmission/reception control unit 27 and instructs the stream decoder 26 to start the decoding of the stream data. The video stream data reproduced by the video server 10 is transmitted through the Internet 12 and received to the transmission/reception control unit 27 in accordance with the distributing request. The received stream data is supplied to the stream decoder 26, decoded into a video signal, and inputted to the AV switch 24.

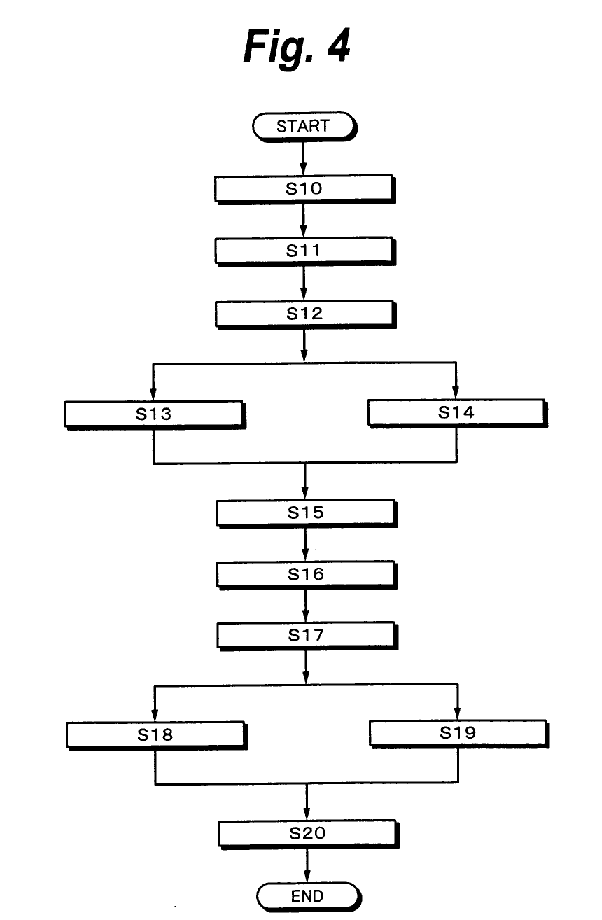

The operation of the stream distribution system according to the first embodiment of the invention constructed as mentioned above will now be described with reference to a flowchart of FIG. 4. This flowchart relates to an example of the operation in the case where the user initially receives the stream data transmitted from the video server 10 by the DTV receiver 20, monitors the video image according to the received stream data, switches the input to another input (for example, the video signal by the analog tuner 31) during the monitoring, monitors it for a little while, thereafter, returns the input to the stream data transmitted from the video server 10 again, and monitors it.

In first step S10, the output of the stream decoder 26 is selected as an input of the DTV receiver 20 by the user. The video image according to the stream data transmitted from the video server 10 is displayed on the display 29 of the DTV receiver 20. That is, the stream data transmitted from the video server 10 is received by the transmission/reception control unit 27, decoded by the stream decoder 26, subjected to predetermined processes by the signal processing unit 28 through the AV switch 24, supplied to the display 29, and displayed.

The video server 10 transmits the stream data on the basis of, for example, the address (IP (Internet Protocol) address in the case where the TCP/IP is used for connection of the Internet 12, or the like) of the DTV receiver 20 on the Internet 12. For example, when the DTV receiver 20 requests the video server 10 to distribute the video data, the address of the DTV receiver 20 is transmitted to the video server 10 together with such a distributing request.

If the DTV receiver 20 received the stream data transmitted from the video server 10, for example, the remocon 21 is operated by the user and an instruction to switch the input to another input (it is assumed here to be the input by the analog tuner 31) is issued (step S11). The remocon 21 modulates the control signal based on this instruction into the infrared signal and transmits it. The infrared signal is received by the remocon photosensing unit 22, demodulated into the original control signal, and supplied to the station selection control microcomputer 23. The station selection control microcomputer 23 interprets the control signal to instruct the input switching and discriminates whether or not the input can be switched. If the station selection control microcomputer 23 determines that the input can be switched, the station selection control signal to instruct to switch the input from the stream decoder 26 to the analog tuner 31 is outputted to the AV switch 24. In addition, a signal showing that the input has been switched is also transferred to the stream player 25 (step S12).

The AV switch 24 switches the input in accordance with the station selection control signal to instruct the input switching which was received from the station selection control microcomputer 23. Thus, the output of the analog tuner 31 is supplied to the signal processing unit 28. A video image based on the output of the analog tuner 31 is displayed on the display 29 (step S13).

In accordance with the station selection control signal, the stream player 25 requests the video server 10 as a transmitting source of the stream data which had been received to pause the stream data. The stream player 25 instructs the stream decoder 26 to stop the decoding process of the stream data and obtains time information showing a point of time of the pause in the stream data. The time information is information showing the time from the head of the stream data and, for example, the time code embedded in the stream data can be used. The invention is not limited to it but the time information can be also obtained by measuring the time from the head of the video image in the DTV receiver 20. The obtained time information is stored into the memory 32 together with the URL of the video server 10 as a transmitting source of the stream data and the title information of the distributed video image (step S14).

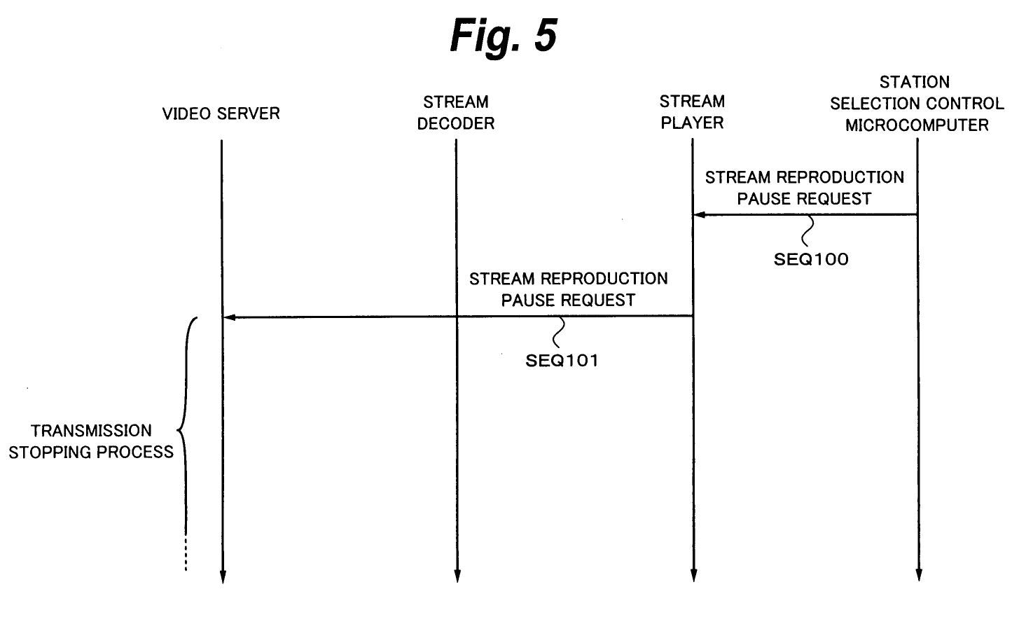

FIG. 5 is a sequence chart schematically showing processes of an example in which the DTV receiver 20 requests the video server 10 to pause the transmission of the stream. First, a request to pause the reproduction of the stream is issued from the station selection control microcomputer 23 to the stream player 25 (SEQ100). The stream player 25 which received such a pause request transmits a request to pause the reproduction of the video stream data transmitted as stream data at present to the video server 10 (SEQ101). When such a pause request is received, the video server 10 executes a process to stop the transmission of the stream data to the DTV receiver 20.

The video image by the analog tuner 31 is monitored by the user for a little while after the input of the DTV receiver 20 is switched to the analog tuner 31 (step S15).

After that, for example, the remocon 21 is operated by the user and an instruction to switch the input from the analog tuner 31 to the stream decoder 26 is outputted (step S16). A control signal based on this instruction is modulated into an infrared signal and the modulated infrared signal is transmitted from the remocon 21 and received to the remocon photosensing unit 22. The remocon photosensing unit 22 demodulates the received infrared signal into the original control signal and supplies it to the station selection control microcomputer 23. The station selection control microcomputer 23 interprets the control signal and discriminates whether or not the input can be switched. If the station selection control microcomputer 23 determines that the input can be switched, the station selection control signal to instruct to switch the input from the analog tuner 31 to the stream decoder 26 is outputted to the AV switch 24. In addition, a signal showing that the input has been switched from the analog tuner 31 to the stream decoder 26 is also transferred to the stream player 25 (step S17).

When the AV switch 24 receives the station selection control signal to instruct the input switching from the station selection control microcomputer 23, it switches the input in accordance with the station selection control signal. Thus, the output of the stream decoder 26 is supplied to the signal processing unit 28. A video image based on the output of the stream decoder 26 can be displayed on the display 29 (step S18).

The stream player 25 requests the distributing source (video server 10) of the distribution stream data to start the reproduction of the stream data so that the video image which had been monitored just before the input is switched to the analog tuner 31 in accordance with the station selection control signal, that is, the distribution stream data received in step S10 mentioned above can be received again. The URL of the video server 10 is stored into the memory 32 when the input is switched from the stream decoder 26 to the analog tuner 31 and the video server 10 is requested to pause the distribution stream data. The time information stored in the memory 32 and showing the point of time of pausing on the stream data is transmitted to the video server 10 together with the stream reproduction start request (step S19).

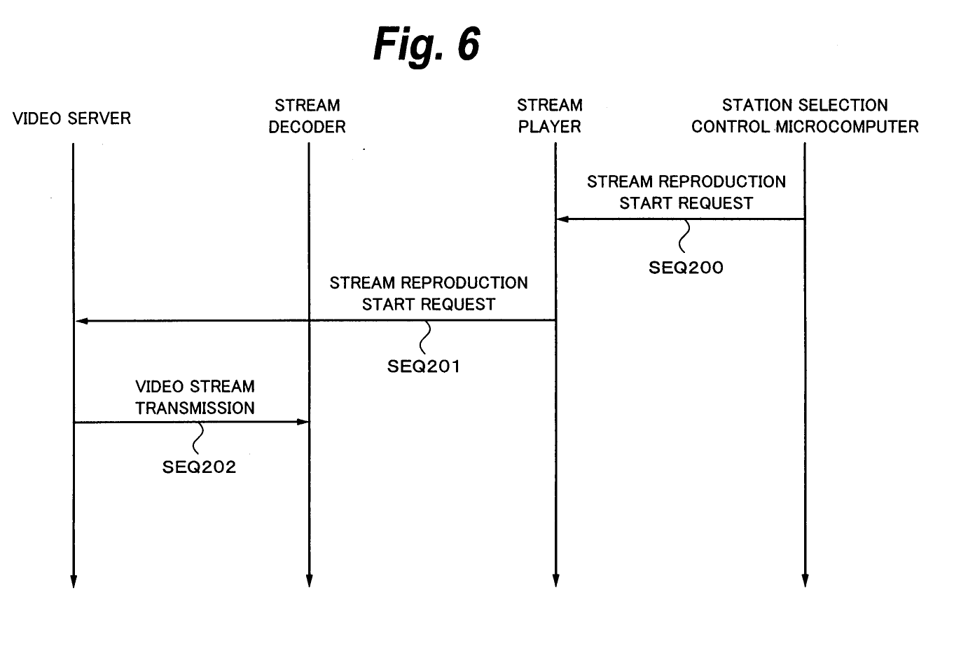

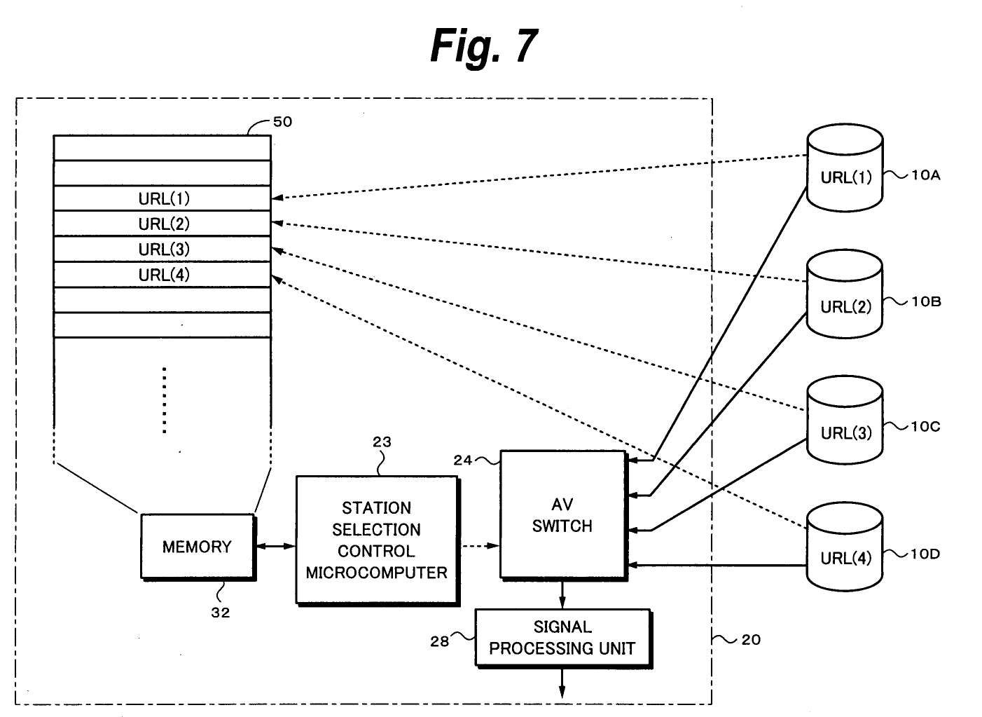

FIG. 6 is a sequence chart schematically showing a process of an example in which the DTV receiver 20 requests the video server 10 to start the stream distribution. First, the request to start the reproduction of the stream data is issued from the station selection control microcomputer 23 to the stream player 25 (SEQ200). The URL (stored in the memory 32) of the video server 10 as a distributing source of the video image which had been monitored just before the input is switched to the analog tuner 31, the time information on the stream data corresponding to the time when the input is switched to the analog tuner 31, and the title information of the video image have been added to the reproduction start request.

The stream player 25 which received the reproduction start request transmits a request to the video server 10 shown by the URL so as to reproduce the corresponding video stream data from the time information on the basis of the URL, the time information, and the title information of the video image added to the reproduction start request (SEQ201). When such a request is received, the video server 10 reproduces the video stream data from the time shown by the time information and transmits it to the DTV receiver 20. The stream data is received by the transmission/reception control unit 27 of the DTV receiver 20 through the Internet 12 and supplied to the stream decoder 26 (SEQ202).

The stream decoder 26 decodes the received stream data into a video signal and supplies it to the AV switch 24. Since the AV switch 24 has switched the input from the analog tuner 31 to the stream decoder 26 in step S18 mentioned above, the video signal inputted from the stream decoder 26 is supplied to the signal processing unit 28, subjected to the predetermined signal processes, supplied to the display 29, and displayed.

Although the invention has been described on the assumption that the memory 32 in which the URL, the title information, and the time information are stored is connected to the station selection control microcomputer 23, it is not limited to such an example. The memory 32 can be connected to the stream player 25. In this case, when the reproduction start request is supplied from the station selection control microcomputer 23 to the stream player 25, the URL, the title information, and the time information stored in the memory 32 are read out by the stream player 25, added to the reproduction start request, and transmitted to the Internet 12.

The second embodiment of the invention will now be described by using FIG. 7. In the second embodiment of the invention, the DTV receiver 20 in the first embodiment of the invention mentioned above holds a history of the monitored distribution stream data, thereby enabling the stream data which had been monitored before to be reproduced later from the position where the reproduction was temporarily stopped upon previous monitoring. In FIG. 7, portions corresponding to those in FIG. 3 mentioned above are designated by the same reference numerals and their detailed explanation is omitted, only portions which are closely related to the second embodiment are shown, and other constructions are omitted.

Video servers 10A, 10B, 10C, and 10D have different URLs (URL(1), URL(2), URL(3), URL(4)) and are connected to the DTV receiver 20 through the Internet (not shown). By designating the URL, the DTV receiver 20 requests the video servers 10A, 10B, 10C, and 10D to distribute video data, respectively, and receives stream data which is transmitted from the video servers 10A, 10B, 10C, and 10D which received such a request. The user can monitor a video image based on the received stream data.

In the second embodiment, in the DTV receiver 20, a history of the stream data which was received and monitored is stored as a history table 50. The memory 32 can be used as a storing destination of the history table 50. In this case, it is desirable to replace the memory 32 by, for example, a non-Volatile memory which is backed up by a battery and enable the history table 50 to be held even in the state where a power source of the DTV receiver 20 is OFF.

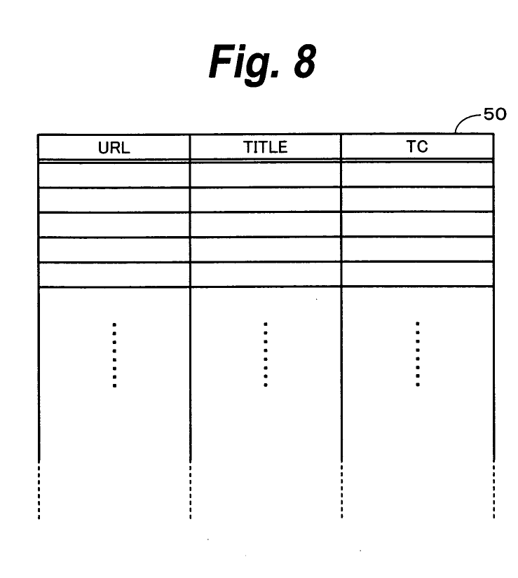

FIG. 8 shows a construction of an example of the history table 50. The URL of the video server as a transmitting source of the received stream data is described in a field “URL”. If the URL has been added to the video data itself distributed as stream data, such a URL is described. Title information of the video data distributed as stream data is described in a field “Title”. The field “Title” is not limited to the title information of the video data but another information such as a file name of the video data or the like can be also used so long as it is an information which can specify the video data in the video server shown by the field “URL”. If the field “URL” shows the video data itself, the field “Title” can be omitted.

Time information of the pause position when a request is made so as to switch the input to another input and pause the reproduction of the video stream data distributed as stream data to the video server during the monitoring of the video image according to the stream data as described in the first embodiment is described in a field “TC”. The time information is time information showing the time from the head of the video image and, for example, a time code embedded in the stream data can be used. The invention is not limited to it but the time information can be also obtained by measuring the time from the head of the video image in the DTV receiver 20.

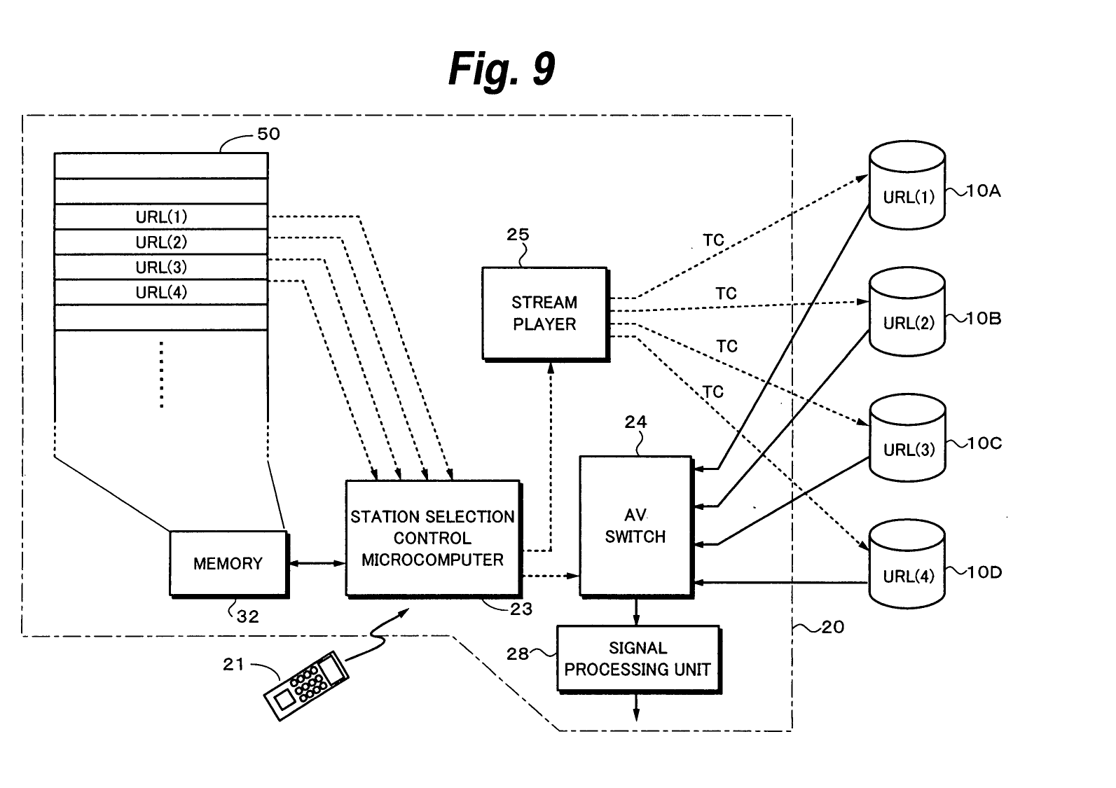

The operation using the history table 50 according to the second embodiment of the invention will now be described with reference to FIG. 9. In FIG. 9, portions corresponding to those in FIGS. 3 and 7 mentioned above are designated by the same reference numerals and their detailed explanation is omitted, only portions which are closely related to the second embodiment are shown, and other constructions are omitted.

In the history table 50, the URLs (URL(1), URL(2), URL (3), URL (4)) of the video servers as transmitting sources of the stream data which was monitored in the past in the DTV receiver 20 are stored in the memory 32 in association with the title information of the monitored video data and the time information (TC: time code) showing the position where the reproduction of the video stream data distributed by the stream data has been paused. In FIG. 9, the title information and the time information in the history table 50 are omitted.

For example, while the user is monitoring the video image by the distribution stream which is distributed from a certain video server by the DTV receiver 20, by executing a predetermined operation to the remocon 21, the stream data which had been received in the past can be reproduced from the position where the reproduction has been stopped at the time of the past reception.

When the user executes the operation to change the channel such as an operation of, for example, the up/down key or the like to the remocon 21 during the reception of the stream data which is transmitted from a certain video server, a control signal formed in accordance with this operation is modulated into an infrared signal and transmitted. The infrared signal is received by the remocon photosensing unit 22 (not shown), demodulated into the original control signal, and supplied to the station selection control microcomputer 23.

On the basis of the control signal, the station selection control microcomputer 23 reads out a set of the URL, the title information, and the time information from the history table 50 stored in the memory 32. It is assumed here that the information regarding the URL(2) is read out. At this time, the latest stored information can be read out first or the oldest stored information can be also read out first. The information stored in a predetermined position in the history table 50 can be also read out first.

On the basis of the information read out from the history table 50, the station selection control microcomputer 23 forms a reproduction start request to instruct the video server 10B shown by the URL(2) to reproduce the video image of the title corresponding to the URL(2) in the history table 50 from the time shown by the time information. The formed reproduction start request is supplied to the stream player 25 and transmitted from the stream player 25 to the corresponding video server 10B as already described by using FIG. 6.

In response to such a request, the video server 10B reproduces the corresponding video stream data and transmits it to the DTV receiver 20 through the Internet. The stream data transmitted from the video server 10B is received by the DTV receiver 20, decoded by the stream decoder 26 (not shown) under the control of the stream player 25, and supplied to the signal processing unit 28 through the AV switch 24. The supplied video signal is subjected to predetermined processes by the signal processing unit 28 and supplied to the display 29 (not shown), and a video image is displayed.

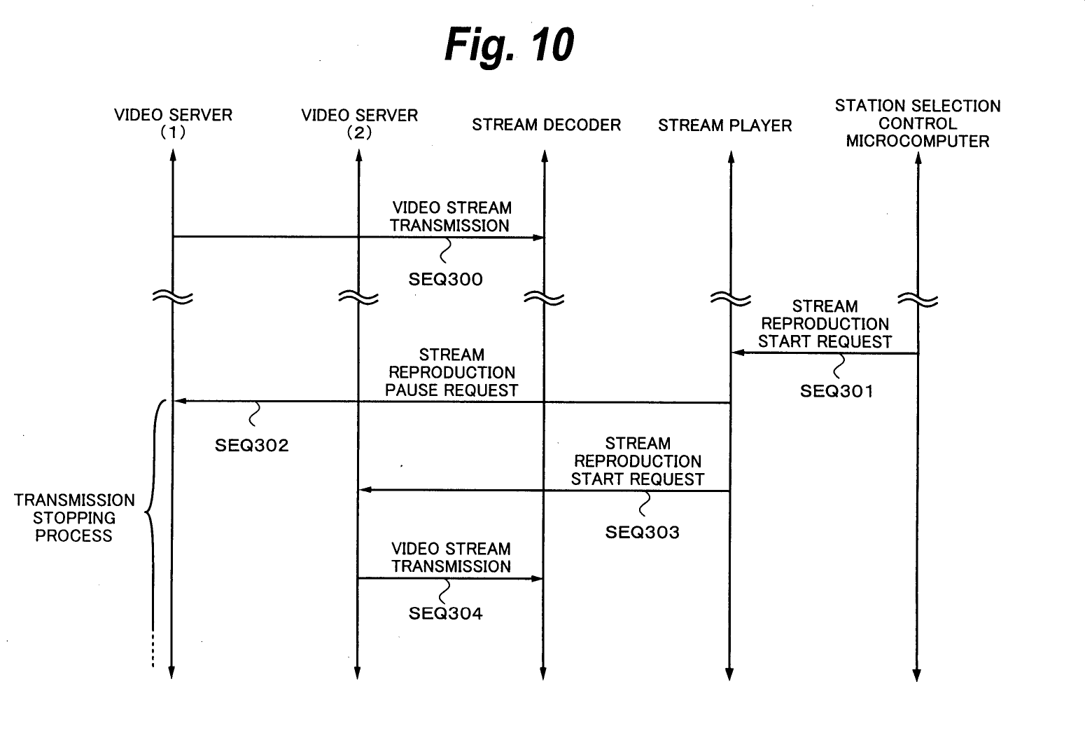

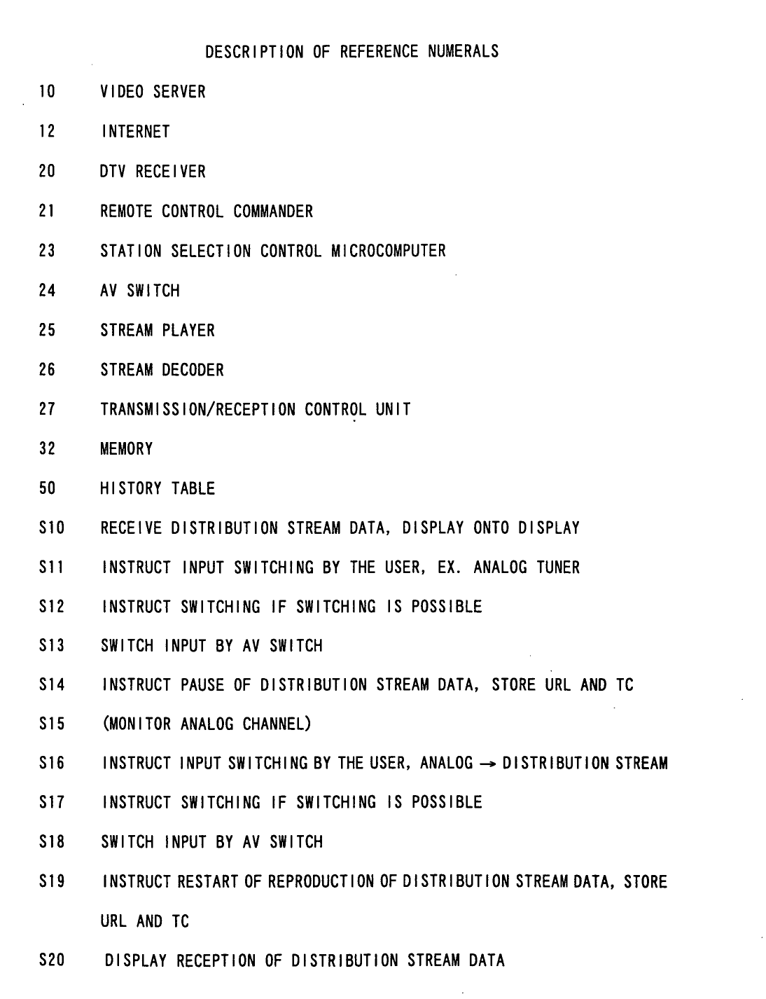

The operation in the case where such an operation as to change the channel has been further executed by the user by using the remocon 21 will now be described by using FIG. 10. It is assumed that the stream data distributed from the video server (1) has initially been received by the DTV receiver 20 and monitored (SEQ300).

On the basis of the control signal according to the operation to the remocon 21, for example, a set of the next URL in the history table 50 stored in the memory 32 is read out by the station selection control microcomputer 23. The reproduction start request is formed on the basis of the information of the read-out set of the URL and supplied to the stream player 25 (SEQ301). The stream player 25 issues an instruction to the stream decoder 26 to pause the decoding of the stream data which has been received at present and decode the stream data which is newly received.

The stream player 25 requests the transmitting source (video server (1) in the example of FIG. 10) of the data stream which has been received at present to pause the transmission of the stream (SEQ302) and transmits the reproduction start request supplied from the station selection control microcomputer 23 to the video server (video server (2) in the example of FIG. 10) corresponding to the relevant URL (SEQ303).

The information of the stream data whose transmission has been paused by SEQ302, that is, the URL of the transmitting source of this stream data, the title information of the video image, and the time information showing the time of the pause on the stream are described in the history table 50. At this time, the URL, the title information, and the time information can be also newly described in the history table 50 or overwritten onto the past corresponding information.

In response to the pause request of the transmitted stream transmission, the video server (1) executes as topping process of the stream transmission. In response to the transmitted reproduction start request, the video server (2) reproduces the video stream data shown in the reproduction start request from the position shown in the time information and transmits it (SEQ304). This stream data is received to the DTV receiver 20, decoded by the stream decoder 26 into the video signal, and supplied to the signal processing unit 28 through the AV switch 24. The supplied video signal is subjected to predetermined processes by the signal processing unit 28 and displayed on the display 29.

In the second embodiment of the invention, as mentioned above, if the user executes the operation to switch the channel by using the remocon 21 during the reception of the stream data transmitted from the video server, it is possible to switch the received stream data on the basis of the information described in the history table 50, start the reproduction from the position where the reproduction has been stopped at the previous time, and display the video image.

As for the operation of the remocon 21, for example, there is a method whereby the reproduction start of one-preceding stream is instructed by the operation to increase the channel (for example, depression of the “up” key) and the reproduction start of one new stream is instructed by the operation to decrease the channel (for example, depression of the “down” key). By this method, a plurality of distribution stream data can be switched and monitored as if the channels of the ordinary television broadcast were switched.

Although the invention has been described above on the assumption that the memory 32 is connected to the station selection control microcomputer 23, the invention is not limited to such an example. As also described in the first embodiment, the memory 32 can be also connected to the stream player 25.

Although the invention has been described above on the assumption that the station selection based on the history table 50 is made when the operation to switch the channel is executed during the reception of the distribution stream data, the invention is not limited to such an example. For example, the station selection based on the history table 50 can be also made by operating a predetermined key of the remocon 21 during the monitoring of the video image by the BS/CS digital tuner 30 or the analog tuner 31.

Further, although the invention has been described above on the assumption that both of the path by which the stream data is transmitted from the video server 10 to the DTV receiver 20 and the path by which the request is transmitted from the DTV receiver 20 to the video server 10 are the Internet 12, the invention is not limited to such an example. That is, the transmission of the stream data from the video server 10 to the DTV receiver 20 and the transmission of the request from the DTV receiver 20 to the video server 10 can be executed by using different communicating means. For example, the transmission of the stream data from the video server 10 to the DTV receiver 20 can be executed by using a radio wave and the transmission of the request from the DTV receiver 20 to the video server 10 can be executed through a network such as Internet 12 or the like.

Moreover, although the invention has been described above on the assumption that the time information showing the pause position of the stream data is stored in the memory 32 held in the DTV receiver 20, the invention is not limited to such an example. That is, the time information showing the pause position of the stream data can be also stored in the video server 10. When the pause request of the stream data transmitted from the DTV receiver 20 to the video server 10 is received to the video server 10, the video server 10 stops the reproduction of the video stream data in response to the received request. In the stopping process, the position information on the video stream data according to the stop position is obtained and stored. When the restart of the reproduction of the video stream data is requested from the DTV receiver 20 at the next time, the reproduction of the video stream data is started on the basis of the stored time information.

As described above, according to the invention, in the case where the input is switched to another input while the video image by the video stream transmitted from the video server is being monitored in the monitor receiver, the monitor receiver side requests the video server to pause the reproduction of the video stream data, and when the input is returned to the video stream data again, it requests the video server to reproduce the video stream data from the position where the reproduction has been paused at the previous time. Therefore, there is such an effect that even if the monitor receiver side does not have the storing means of the video data such as a hard disk drive or the like, the reproduction can be restarted from the previous stop position of the video stream which is transmitted from the video server.

According to the second embodiment of the invention, the history of the video stream data received in the past in the monitor receiver is stored together with the pause position information of the video stream data and the video server is requested so as to reproduce the video stream data stored in the history from the position where the reproduction has been stopped at the previous time by the channel switching operation. Therefore, there is such an effect that the user can switch and monitor the video stream data as if he switched the channels of the ordinary television broadcast.

1. A receiving apparatus which can switch and receive a television broadcast and stream data, comprising:
reproducing means for reproducing the received stream data;
switching means for switching an input between an input from said reproducing means and another input; and
communicating means for communicating with a transmitting source of said stream data,
wherein in the case where said input is switched from the input from said reproducing means to said another input by said switching means during the reproduction of said stream data by said reproducing means, a stop request to stop transmission of said stream data is transmitted to the transmitting source of said stream data by said communicating means, and
in the case where said input is switched again from said another input to an output from said reproducing means by said switching means, a start request to start the reproduction of said stream data from a position where the transmission of said stream data has been stopped is transmitted to said transmitting source of said stream data by said communicating means.

2. A receiving apparatus according to claim 1, further comprising
position information obtaining means for obtaining position information showing a position on said stream data which is reproduced by said reproducing means at a point of time when said input has been switched from the input from said reproducing means to said another input by said switching means, and
wherein after said input had been switched from the input from said reproducing means to said another input by said switching means during the reproduction of said stream data by said reproducing means, in the case where said input was switched again from said another input to the input from said reproducing means by said switching means, said start request to start the reproduction of said stream data from the position based on said position information obtained by said position information obtaining means is transmitted to said transmitting source of said stream data by said communicating means.

3. A receiving apparatus according to claim 1, wherein
the reception of the stream data and the transmission of said stop request or said start request are executed by different communicating means.

4. A receiving apparatus according to claim 1, wherein
in the case of transmitting said start request, an address of said receiving apparatus is transmitted together with said start request.

5. A receiving apparatus according to claim 1, wherein
in the case of transmitting said start request, information of said transmitting source is transmitted together with said start request.

6. A receiving apparatus according to claim 1, wherein
in the case of transmitting said start request, information showing the stream data is transmitted together with said start request.

7. A receiving apparatus according to claim 1, further comprising
history storing means for storing information of said transmitting source of said stream data reproduced by said reproducing means as a history, and
wherein if the input is switched by said switching means during the reproduction of said stream data by said reproducing means, said transmitting source is selected from said history storing means in accordance with the switching of said input by said switching means and said start request is transmitted to said selected transmitting source by said communicating means.

8. A receiving apparatus according to claim 7, wherein
a URL of said transmitting source has been stored in said history.

9. A receiving apparatus according to claim 7, wherein
URLs of the streams stored in said transmitting source have been stored in said history, respectively.

10. A station selecting method which can switch and receive a television broadcast and stream data, comprising the steps of:
reproducing the received stream data;
switching an input between an input from said reproducing step and another input; and
communicating with a transmitting source of said stream data,
wherein in the case where said input is switched from the input from said reproducing step to said another input by said switching step during the reproduction of said stream data by said reproducing step, a stop request to stop transmission of said stream data is transmitted to the transmitting source of said stream data by said communicating step, and
in the case where said input is switched again from said another input to an output from said reproducing step by said switching step, a start request to start the reproduction of said stream data from a position where the transmission of said stream data has been stopped is transmitted to said transmitting source of said stream data by said communicating step.

11. A stream distribution system for distributing stream data to a receiving apparatus which can switch and receive a television broadcast and the stream data, comprising:
a stream data server for reproducing and transmitting the stream data; and
the receiving apparatus having reproducing means for receiving said stream data transmitted from said stream data server and reproducing said received stream data, switching means for switching an input between an input from said reproducing means and another input, and communicating means for communicating with said stream data server,
wherein in the case where said input is switched from the input from said reproducing means to said another input by said switching means during the reproduction of said stream data by said reproducing means, said receiving apparatus transmits a stop request to stop the transmission of said stream data to said stream data server by said communicating means,
said stream data server stops the transmission of said stream data by said stream data server in accordance with said stop request,
in the case where said input is switched again from said another input to the input from said reproducing means by said switching means, said receiving apparatus transmits a start request to start the reproduction of said stream data from a position where the transmission of said stream data has been stopped to said stream data server by said communicating means, and
said stream data server reproduces said stream data from the position where the transmission of said stream data has been stopped and transmits said stream data to said receiving apparatus in accordance with said start request.

12. A stream distribution system according to claim 11, wherein
the reception of the stream data from said stream data server and the transmission of said stop request or said start request to said stream data server are executed by different communicating means.

13. A stream distribution system according to claim 11, wherein
in the case of transmitting said start request, an address of said receiving apparatus is transmitted together with said start request.

14. A stream distribution system according to claim 11, wherein
in the case of transmitting said start request, information showing said stream data server is transmitted together with said start request.

15. A stream distribution system according to claim 11, wherein
in the case of transmitting said start request, information showing the stream data is transmitted together with said start request.

16. A stream distribution system according to claim 11, wherein
said receiving apparatus further comprises position information obtaining means for obtaining position information showing a position on said stream data which is reproduced by said reproducing means at a point of time when said input has been switched from the input from said reproducing means to said another input by said switching means, and after said input had been switched from the input from said reproducing means to said another input by said switching means during the reproduction of said stream data by said reproducing means, in the case where said input was switched again from said another input to the input from said reproducing means by said switching means, said start request to start the reproduction of said stream data from the position based on said position information obtained by said position information obtaining means is transmitted to said stream data server by said communicating means.

17. A stream distribution system according to claim 11, wherein
said receiving apparatus further comprises history storing means for storing information, as a history, of said stream data server which transmitted said stream data reproduced by said reproducing means, and
if the input is switched by said switching means during the reproduction of said stream data by said reproducing means, said stream data server is selected from said history storing means in accordance with the switching of said input by said switching means and said start request is transmitted to said selected stream data server by said communicating means.

18. A stream distribution system according to claim 17, wherein
a URL of said transmitting source has been stored in said history.

19. A stream distribution system according to claim 17, wherein
URLs of the streams stored in said transmitting source have been stored in said history, respectively.
